(19) United States
(12) Patent Application Publication
(10) Pub. No.: US 2025/0058387 A1
(43) Pub. Date: Feb. 20, 2025

(54) ARCUATE CUTTING TOOL PART, CUTTING TOOL AND MACHINING DEVICE

(71) Applicant: EVOBEND GmbH, Ainring (DE)

(72) Inventor: Nikolaus Franz DUSCHER, Bergheim bei Salzburg (AT)

(73) Assignee: EVOBEND GmbH, Ainring (DE)

(21) Appl. No.: 18/800,402

(22) Filed: Aug. 12, 2024

(30) Foreign Application Priority Data
Aug. 16, 2023 (DE) 10 2023 121 959.6

(51) Int. Cl. B23D 35/00

(52) U.S. Cl. CPC B23D 35/004

(57) ABSTRACT

An arcuate cutting tool part for a machining device for cutting flat material, such as sheet metal, is disclosed. The arcuate cutting tool part comprises a radially outer cutting edge area having at least one first arcuate cutting edge, an attachment arrangement for attachment to the machining device, a first coupling arrangement having a first coupling portion, and a second coupling arrangement having a second coupling portion, wherein the arcuate cutting tool part defines a circumferential direction in accordance with the arcuate shape, and wherein the first and/or the second coupling arrangements are configured to be releasably coupled to at least one further arcuate cutting tool part in the circumferential direction.

### CROSS-REFERENCE TO RELATED APPLICATION

This patent application claims priority from German patent application no. 10 2023 121 959.6 filed on Aug. 16, 2023, the entire disclosure of which is incorporated herein by reference.

### TECHNICAL FIELD

The present invention relates to an arcuate cutting tool part for a machining device for cutting flat material, a cutting tool having at least one such cutting tool part, and a machining device having at least one such arcuate cutting tool part.

### BACKGROUND

With a view to the technical background, the present invention relates to a machining device for cutting flat material, such as sheet metal, comprising a base including a support table for the flat material, the base defining a feed direction in which the flat material can be fed into the machining device, a first cutting device configured to cut the flat material transversely to the feed direction, and a second cutting device configured to cut the flat material in the feed direction. Such machining devices are known from the prior art in the field of sheet metal machining. It is common practice to feed flat material, such as sheet metal, into such machining devices to cut it longitudinally and transversely.

A cutting wheel is commonly provided precisely in cutting devices designed for cutting the flat material in the feed direction. Such a cutting wheel is usually arranged on a carrier of the machining device. As use progresses, the cutting wheel may be subject to wear. In such case, the cutting wheel needs to be replaced, which usually involves the removal of the worn cutting wheel and the installation of a new cutting wheel in the machining device. In known machining devices, such a replacement is relatively complex and time-consuming. Typically, many work steps must be performed. One of the reasons for this is that the carrier of the cutting wheel must first be removed to afterwards remove the worn cutting wheel from the carrier and then mount the new cutting wheel on the carrier. Finally, the carrier must be reinstalled in the machining device.

It is thus an object of the present invention to enable improved maintainability and replaceability of the cutting device or cutting devices for machining devices of the type mentioned at the beginning. It is another object of the present invention to provide an improved cutting tool for cutting flat material. In addition, it is an object of the present invention to provide a machining device of the type mentioned at the beginning with improved maintainability.

### DESCRIPTION OF THE INVENTION

At least one of the aforesaid objects is achieved with the arcuate cutting tool part according to the invention for a machining device for cutting flat material, such as sheet metal. The cutting tool part comprises a radially outer cutting edge area having at least one first arcuate cutting edge, an attachment arrangement for attachment to the machining device, and a first coupling arrangement having a first coupling portion, and a second coupling arrangement having a second coupling portion, wherein the arcuate cutting tool part defines a circumferential direction in accordance with the arcuate shape, and wherein the first and/or the second coupling arrangements are configured to be releasably coupled to at least one further arcuate cutting tool part in the circumferential direction.

The cutting tool part according to the invention enables easy coupling to and decoupling from the further arcuate cutting tool part. Furthermore, it is possible to form a cutting tool from at least two cutting tool parts. The inventors have become aware that for this purpose it is particularly advantageous to divide the cutting tool into at least two cutting tool parts in the circumferential direction. The further cutting tool part and the cutting tool part according to the invention may be identical in construction.

In one embodiment of the invention, it may be provided that the first and the second coupling arrangements are configured such that imaginary coupling to the respective other of the first and second coupling arrangements is provided. Such coupling can be understood to mean that imaginary planar and/or at least partially positive abutment of the coupling arrangements with one another may be provided. This may be due to the geometric shapes of the coupling arrangements. It is understood that such imaginary coupling can be provided without an additional component arranged between the coupling arrangements. Coupling may block relative movement in at least one spatial direction. Preferably, movement is blocked in all spatial directions.

In one embodiment of the invention, it may be provided that the first and the second coupling arrangements are substantially identical. This makes the cutting tool part specifically compatible for coupling to the further cutting tool part.

In an alternative embodiment of the invention, it may be provided that the first and the second coupling arrangements are different from each other at least in part and/or sections. This helps to provide particularly defined coupling to the further cutting tool part.

In another embodiment of the invention, it may be provided that the first and the second coupling portions are configured to be at least partially, preferably to a large extent, particularly preferably completely complementary to each other. This helps to provide particularly defined coupling. This is particularly advantageous in the case of coupling to an identical further cutting tool part. A particularly advantageous embodiment of the complementary design of the coupling portions is to provide positive coupling of the coupling portions.

In one embodiment of the invention, it may be provided that the first and/or the second coupling portions have a geometric shape that enables positive coupling to the other of the first and second coupling portions.

In one embodiment of the invention, it may be provided that at least one of the coupling arrangements has at least one recess for receiving a connecting means, in particular a screw. This helps to provide particularly easy and effective releasable coupling to the further arcuate cutting tool part. Preferably, the first and the second coupling arrangements have at least one such recess. The recess may extend at least partially along the circumferential direction. It may be provided that the at least one recess has a central axis that is perpendicular to a surface of the coupling portion of the coupling arrangement.

In one embodiment of the invention, it may be provided that the recess of at least one of the first and the second coupling arrangements is configured as a threaded hole with an internal thread.

In one embodiment of the invention, it may further be provided that the recess of the other of the first and the second coupling arrangements is configured to receive a screw head.

In one embodiment of the invention, the cutting tool part further comprises a radially inner, in particular arcuate, portion. It may be provided to at least partially surround a part of the machining device, in particular a guide cylinder of the machining device. The attachment arrangement may be configured as the arcuate portion and thus serve for attachment to the machining device.

In another embodiment of the invention, it may be provided that the inner portion is further provided to rest against the guide cylinder of the machining device. This helps to provide particularly defined guidance of the cutting tool part relative to the machining device.

In one embodiment of the invention, it may be provided that the radially outer cutting edge area, in particular at least the first cutting edge, and/or the inner portion are configured to have the shape of a segment of a circle. It may further be provided that the radially outer cutting edge area, in particular at least the first cutting edge, and/or the inner portion form an angle of the shape of a segment of a circle of substantially 180°. Other angles, for example 90° or 45°, as well as other integer divisors of 360°, may be provided.

In one embodiment of the invention, it may be provided that the cutting tool part is configured to have the shape of a segment of a ring, in particular of a segment of a circular ring. The ring segment shape may have a constant thickness in the radial direction.

In another embodiment of the invention, it may be provided that the arcuate shape of the cutting tool part forms an angle of substantially 180°. Other angles, for example 90° or 45°, as well as other integer divisors of 360°, may be provided.

In one embodiment of the invention, it may be provided that the attachment arrangement comprises at least one fastening hole, preferably a plurality of fastening holes, particularly preferably a plurality of fastening holes arranged along a pitch circle, for at least partially receiving a respective connecting means, in particular respective screws. Preferably, the at least one fastening hole extends in a direction perpendicular to the radial direction and/or circumferential direction.

In one embodiment of the invention, it may be provided that the machining device comprises a cutting tool part carrier for attachment of the cutting tool part to the machining device. The attachment arrangement may further comprise a contact portion for contacting, in particular contacting in a planar manner, the cutting tool part carrier.

At least one of the objects discussed at the outset is further achieved with an arcuate cutting tool comprising a first cutting tool part of any one of the above types, and a second cutting tool part of any one of the above types, wherein the first coupling arrangement of the second cutting tool part is coupled to the first or the second coupling arrangement of the first cutting tool part.

In one embodiment of the cutting tool according to the invention, it may be provided that the second coupling arrangement of the second cutting tool part is coupled to the other of the first and the second coupling arrangements of the first cutting tool part.

In one embodiment, the cutting tool may further comprise at least one, preferably at least two, connecting means for releasably coupling the first cutting tool part to the second cutting tool part.

In one embodiment of the cutting tool according to the invention, it may be provided that the cutting tool parts are similar, in particular identical.

At least one of the objects discussed at the outset is further achieved with a machining device for cutting flat material, such as sheet metal, comprising a base including a support table for the flat material, the base defining a feed direction in which the flat material can be fed into the machining device, and a cutting device arrangement configured to cut the flat material, wherein the cutting device arrangement comprises at least one cutting tool part of any one of the above types and/or a cutting tool of any one of the above types for cutting the flat material.

In one embodiment of the machining device according to the invention, it may be provided that the cutting device arrangement comprises a first cutting device configured to cut the flat material transversely to the feed direction, and/or comprises a second cutting device configured to cut the flat material in the feed direction, wherein the first cutting device or the second cutting device comprises the cutting tool part and/or the cutting tool.

In one embodiment of the machining device according to the invention, it may further be provided that the machining device further comprises a separative machining (cutting) unit configured to be displaceable in the machining device relative to the base transversely to the feed direction, wherein the separative machining unit is configured to subject the flat material to separative machining in sections.

In one embodiment of the invention, the machining device of the above type may further comprise a separative machining unit configured to be displaceable in the machining device relative to the base transversely to the feed direction, wherein the separative machining unit is configured to subject the flat material to separative machining or punching in sections.

This embodiment thus provides for the combination of the machining steps of transverse cutting and longitudinal cutting with local separative machining, for example in the form of punching, in a single machining device, i.e. in a single machine, by providing the separative machining unit. In addition to the two cutting devices, the punching unit is provided in the machine, which makes it possible to carry out local punching and separative machining on the flat material in one and the same machine. The embodiment thus achieves a compact machine for carrying out all the separative machining steps normally required when machining flat material, in particular sheet metal.

In the context of the present disclosure, where reference is made to a support table, this does not necessarily mean that it is a table with a planar extended table top. Rather, this means that the flat material can be introduced into the machining device via an extended support and fed to the other components of the same. This support or the support table may, for example, be formed by a large number of rollers or roller conveyors.

It may be provided that the support table has guide members for aligning the longitudinal material. In addition, the support table may also have molding rollers to straighten the flat material, i.e. to smooth out any deformations, such as unevenness, local bulges, curvatures, etc.

One embodiment of the invention provides that a guide portal is provided on the base, which is arranged transversely to the support table, the guide portal having a guide device which makes the separative machining unit displaceable in a guided manner relative to the base. The separative machining unit is thus displaceable along the guide device on the guide portal so that it can machine any location of the flat material as the latter is fed through the machine. It is preferable for the guide device to have a linear guide.

In one embodiment of the invention, it may be provided that the flat material is displaceable on the support table relative to the base in the feed direction with a feed device. Such displacement may take place by means of a displacement device, e.g. driven feed rollers or the like. Furthermore, the flat material can be stopped and fixed in a certain desired position. It may be provided that the base has a fixing device for temporarily fixing the flat material on the support table.

In one embodiment of the invention, it may be provided that the guide portal is configured to be displaceable relative to the base in the feed direction. In other words, the guide portal itself may be displaceable relative to the base, for example such that it can be moved together with the flat material in the feed direction relative to the base within a specific displacement range. However, it may also be possible to temporarily stop the flat material and move the guide portal relative to the flat material parallel to the intended feed direction to perform certain machining steps. This makes it possible, for example, to cut any contour in the flat material. Furthermore, the guide portal may be displaceable transversely to the feed direction relative to the base.

In one embodiment of the invention, it may be provided that the first cutting device comprises a guillotine shearing device or a rotary shearing device. Typically, such cutting devices are used for cutting the flat material in the transverse direction, i.e. transverse to the feed direction. It may further be provided that the second cutting device comprises a circular blade device or a rotary shearing device. Such cutting devices are usually used for cutting the flat material in the longitudinal direction, i.e. parallel to the feed direction.

As already discussed at the outset, there are various options to design the separative machining unit. It is important that the separative machining unit is suitable for carrying out localized separative machining operations in the flat material, i.e. producing locally defined recesses in the flat material or splitting the flat material along a predetermined profiled line. In this context, it may be provided that the separative machining unit is configured with a laser machining unit and/or a punching unit. The separative machining unit may further be designed as a waterjet cutting machining head. If designed as a laser machining unit, the separative machining unit may have laser optics that provide a laser beam that can be focused onto the flat material. If designed as a punching unit, the separative machining unit is equipped with at least one punching tool.

In this case, it may be provided that the punching unit is configured as a hydraulic or/and mechanical punching unit. In the case of a hydraulic punching unit, the stroke movement is achieved by controlling a hydraulic control system. In the case of a mechanical punching unit, the stroke movement is achieved mechanically, for example with a spindle drive. Moreover, a mechanical punching unit may also have a spline drive, i.e. the stroke movement can be achieved by displacing different spline surfaces in relation to each other.

To ensure that punching is as flexible and multi-functional as possible, one embodiment of the invention provides for the punching unit to comprise a plurality of punching tools that can be optionally selected for machining the flat material. It is thus possible to set up a tool receptacle with a plurality of punching tools, wherein in each case the required punching tool is controllable via a separate reciprocating piston that can selectively control one of the punching tools held in the tool receptacle by twisting it relative to the tool receptacle and use it to perform a punching operation. The other punching tools provided in the tool receptacle remain passive.

According to the invention, it may be provided that the mechanical punching unit is configured with a motor-driven double-spindle arrangement with spindle drives rotating in opposite directions and a drive control, wherein a force output member is selectively displaceable in a stroke direction perpendicular to the feed direction, in particular perpendicular to a main direction of extension of the flat material, and/or twistable relative thereto. In such an embodiment, the force output member can be used to control a punching unit having a plurality of punching tools. By selecting the angular position of the force output member, the reciprocating piston of a tool assembly of the punching unit comprising the plurality of punching tools can be twisted to selectively control the desired punching tool.

As an alternative to a double-spindle arrangement with spindle drives rotating in opposite directions, in one embodiment of the invention, it is also possible to equip the punching unit with only one spindle which may be configured to rotate either clockwise or anti-clockwise and which may be coupled to a shaft guide that is optionally locked against twisting. Such components are also known as lifting/rotary modules.

The disclosure further relates to a punching unit for punching flat material, in particular a machining head for a machining device of the type previously described, wherein the machining head comprises a housing defining a stroke axis, a mechanical or hydraulic lifting device comprising a force output member, a tool receptacle for receiving at least one cutting or punching tool, which is mounted in the housing so as to be rotatable about an axis of rotation, at least one cutting or punching tool which can be received in the tool receptacle and is displaceable in the direction of the stroke axis along a tool longitudinal axis, wherein the cutting or punching tool is displaceable along its tool longitudinal axis via the force output member, a rotatable positioning device for rotatably positioning the at least one cutting or punching tool, and a die unit which is configured to interact with the at least one cutting or punching tool and can be aligned in accordance with its rotatable positioning.

Such a punching unit may be provided in a machining device of the type described above.

Such a punching unit allows flexible punching of flat material. The movement is performed through the mechanical or hydraulic lifting device. The tool receptacle can be twisted separately relative to the lifting device through the rotatable positioning device. This allows the tool selected for cutting or punching to be aligned at any angle. If a number of cutting or punching tools are provided, they can also be controlled separately. As is well known, to achieve a high-quality machining result, a die unit is provided to receive and guide the cutting or punching tool during punching.

In one embodiment of the punching unit, it may be provided that the rotatable positioning device is configured to rotatably position the cutting or punching tool about its tool longitudinal axis and/or about the stroke axis.

In the punching unit, it may further be provided that the lifting device is configured with a hydraulic piston that displaces the force output member in the lifting device by at least a predetermined stroke distance.

An advantageous embodiment of the punching unit provides that the lifting device is configured with a spindle arrangement, in particular with a double-spindle arrangement, wherein the double-spindle arrangement is equipped with a first spindle drive and a second spindle drive. The first and second spindle drives may have drive spindles configured to rotate in opposite directions, wherein in first and second spindle drives that are rotatably driven in the same direction, the force output member can be positioned rotatably about the stroke axis, wherein in first and second spindle drives that are rotatably driven in opposite directions, the force output member is displaceable along the stroke axis in the stroke direction.

In this embodiment of the punching unit, it may further be provided that the tool receptacle comprises a turret with a plurality of cutting or punching tools received therein, each of the cutting or punching tools being selectively activatable for machining the flat material. One embodiment further provides that the force output member comprises a coupling member that is arranged eccentrically relative to the stroke axis and can optionally be positioned rotatably about the stroke axis, wherein the respective cutting or punching tool can be activated for machining the flat material in accordance with the rotational position of the coupling member about the stroke axis while cutting or punching tools that have not been activated remain passive.

In addition, this embodiment may provide that the tool receptacle is assigned a reciprocating piston which can be coupled to the force output member and which makes the respectively activated cutting or punching tool displaceable along its tool longitudinal axis in the stroke direction.

To position the respective punching tool in a predetermined angular position, one embodiment of the machining head provides for a rotary drive to be assigned to the tool receptacle, with which the tool receptacle can be positioned rotatably about the stroke axis relative to the housing, wherein the alignment of the at least one cutting or punching tool of the stroke axis can be changed in accordance with the rotational position of the tool receptacle.

Further, one embodiment of the punching unit provides for a rotary drive to be assigned to the die unit, with which a die that receives the respectively activated cutting or punching tool and is complementary to the activated cutting or punching tool can be positioned rotatably about the stroke axis relative to the housing, wherein the die can be positioned in accordance with the alignment and positioning of the activated cutting or punching tool of the stroke axis.

### BRIEF DESCRIPTION OF THE DRAWINGS

Below, the invention is explained by way of example with reference to figures. In the drawings:

FIG. 1 is a spatial representation of a machining device;

FIG. 2 is a spatial sectional view along a vertical sectional plane of the machining device in the feed direction;

FIG. 3 is a spatial representation of an arcuate cutting tool part according to the invention;

FIG. 4 is a sectional view of the arcuate cutting tool part according to the invention;

FIG. 5 is a bottom view of the arcuate cutting tool part according to the invention;

FIG. 6 is a detailed view of the arcuate cutting tool part according to the invention;

FIG. 7 is a representation of a cutting tool according to the invention;

FIG. 8 is a sectional view of the arcuate cutting tool according to the invention;

FIG. 9 is a detailed view of the machining device comprising the cutting tool according to the invention;

FIG. 10 is a spatial representation of an upper part of a punching unit according to one embodiment of the invention;

FIG. 11 is a spatial representation of the upper part of the punching unit, with part of the housing being omitted to make the double-spindle arrangement visible;

FIG. 12 is a sectional view along the stroke axis of the upper part of the punching unit;

FIG. 13 is a detail of the machining device according to one embodiment, showing a feeder upstream of the punching unit with respect to the feed direction as well as a die device of the punching unit in a section containing an axis;

FIG. 14 is a spatial view showing a detail of FIG. 12 to illustrate the interaction between the individual components of the punching unit;

FIG. 15 is a spatial partial sectional view illustrating the tool receptacle;

FIG. 16 is a bottom view of the punching unit;

FIG. 17 is a spatial sectional view of the die device, containing an axis; and

FIG. 18 is another spatial sectional view of the die device, containing an axis.

### DETAILED DESCRIPTION OF THE INVENTION

FIG. 1 is a spatial representation of a machining device according to the invention, generally referred to as 10. It comprises a base 12 which is firmly attachable to a floor and which includes a support table 14 on which the flat material FM can be placed and displaced in a feed direction V. Drive rollers 16, 18 which can be driven and between which the flat material FM can be passed are used for displacement. Manually operated rollers may be provided instead of or in addition to the drive rollers 16. The flat material FM may, for example, be an even material, in particular sheet material. The base 12 further comprises two side walls 20, 22 on and between which the support table 14 and the various drive rollers 16, 18 are mounted.

Furthermore, a guide portal 24 is attached to the two side walls 20, 22, which extends transversely to the support table 14 above and below the plane along which the flat material FM is guided. This guide portal 24 is attached for linear displacement along a linear guide 30 relative to the base 12 by means of lateral portal holders 26, 28. The guide portal 24 can thus be displaced to a certain extent relative to the base 12 in the feed direction V by means of the two portal holders 26, 28. A first linear guide 32 is attached to the guide portal 24 in the transverse direction Q. This linear guide 32 serves to displace a punching unit 34, which will be explained in detail below, relative to the guide portal 24 in the transverse direction Q and thus transversely to the base 12. Where reference is made to a movement in one direction, for example a movement in the feed direction V or in the transverse direction Q, this may also include a corresponding movement in the opposite direction.

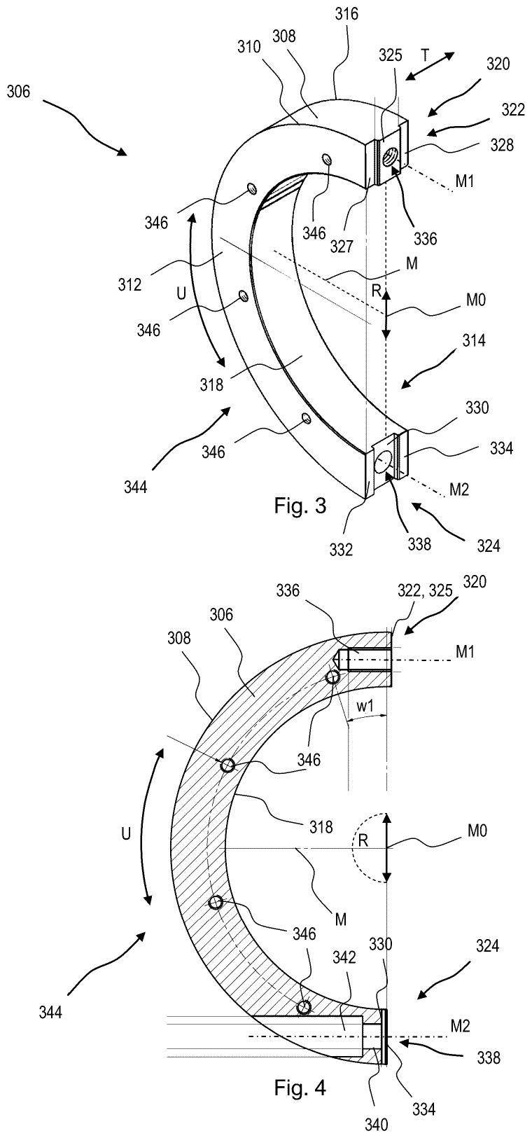

FIG. 1 further shows two cutting devices 40, 42 of a cutting device arrangement 41. A first cutting device 40 is configured as a guillotine shearing device and serves to cut the flat material in the transverse direction Q. A second cutting device 42 is configured as a rotary shearing device, in particular in accordance with an arcuate cutting tool 300, as will be explained in more detail in connection with FIGS. 3 to 8. The arcuate cutting tool 300 serves to cut the flat material FM in the longitudinal direction, i.e. in the feed direction V.

The first cutting device 40 is attached so as to be stationary, with a blade 44 being displaceable in the in height direction Z by means of a linear guide. An eccentric drive 46 is provided for this purpose. In the second cutting device 42, a rotary blade 48, namely the arcuate cutting tool 300, is provided so as to be linearly displaceable on a guide cylinder 50. The arcuate cutting tool 300 may contact the guide cylinder 50. In any case, it is intended to surround the guide cylinder 50. In the present case, a cutting tool part carrier 302 is provided on the machining device 10, which is ring-shaped and also surrounds the guide cylinder 50. The arcuate cutting tool is releasably attached to the cutting tool part carrier 302. The cutting tool part carrier 302 is coupled to a linear guide 304 configured to linearly displace the cutting tool part carrier 302 and the arcuate cutting tool 300 coupled thereto on the guide cylinder 50 along the transverse direction Q.

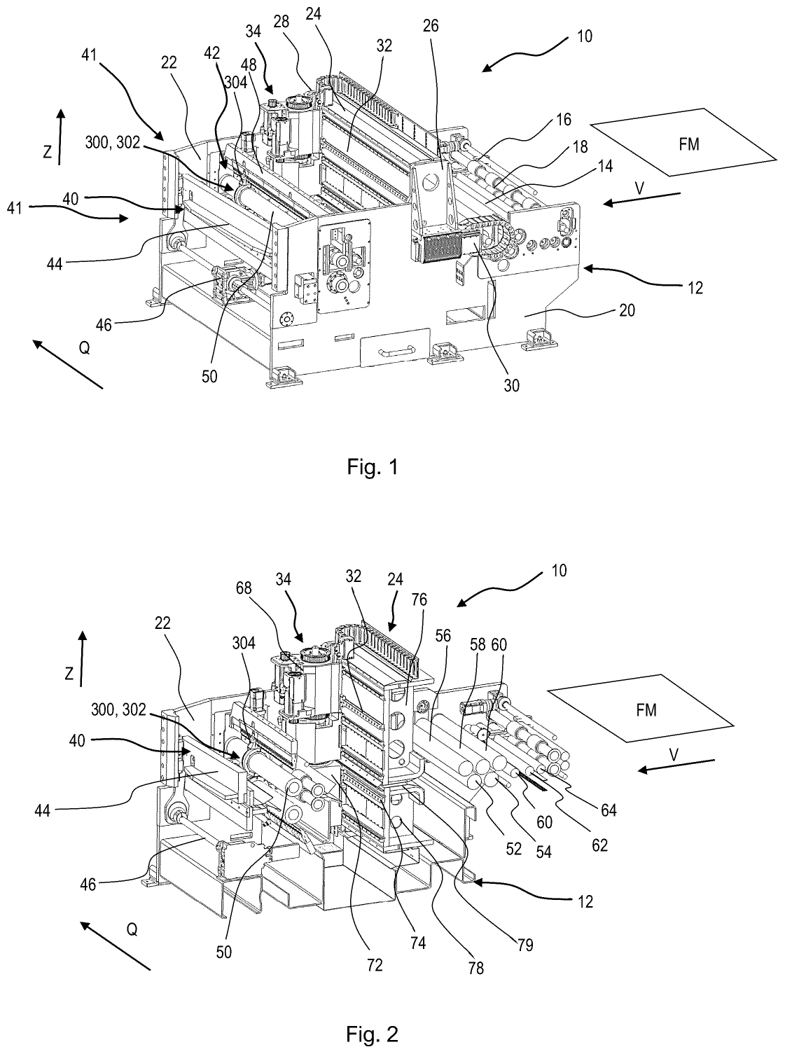

Details of this machine are also visible in the illustration of FIG. 2 in which the front side wall 20 of FIG. 1 was cut away for a better view of the inside of the machine. It can be seen that a series of guide rollers 52, 54, 56, 58, 60, 62, 64 for guiding, positioning, clamping and displacing the flat material FM are mounted in the base 12 or on the side walls 20, 22. The portal carries the punching unit 34 which comprises a machining head 68 and a die unit 72. Their mode of operation will also be described in detail below. A further linear guide 74 is provided to guide the die unit 72. It allows synchronous displacement of the machining head 68 and the die unit 72 in the transverse direction Q along the portal 24 and the further guide unit 70.

It should also be noted that the portal 24 is configured in two parts. It comprises an upper portion 76 or carrier and a lower portion 78 or carrier that are separated from each other by a guide gap 79. The flat material FM is passed through the guide gap 79. To guide the lower portion 78 in the feed direction V, it may be coupled to the linear guide 30 or a further linear guide configured on the machining device 10 below and parallel to the linear guide 30.

FIG. 3 is a spatial representation of an arcuate cutting tool part 306 according to the invention while FIG. 4 is a sectional view of the arcuate cutting tool part 306. The arcuate cutting tool part 306 comprises a radially outer cutting edge area 308 having at least one first arcuate cutting edge 310. The first arcuate cutting edge 310 is formed on the edge of the cutting tool part 306, on which the radially outer cutting edge area 308 merges into an even, planar side area 312. In analogy to the even side area 312, a further even, planar side area 314 (not shown herein) is formed on the back of the arcuate cutting tool part 306. In the present case, the even side areas 312, 314 are parallel to one another, similar and level. As in the present case, it may be provided that the radially outer cutting edge area 308 comprises at least one further cutting edge, namely the second cutting edge 316, which extends at the edge where the radially outer cutting edge area 308 merges into the even, planar side area 314. The radially outer cutting edge area 308, together with at least the first cutting edge 310, extends over an angle of substantially 180° of the arcuate cutting tool part 306. The first cutting edge 310 thus extends in the circumferential direction over the entire radially outer cutting edge area 308. The radially outer cutting edge area 308 is configured to have the shape of a segment of a circle, in the present case the shape of a segment of a semicircle.

The arcuate cutting tool part 306 further comprises an inner portion 318 adapted to partially surround the guide cylinder 50 of the machining device 10. It may be provided that the inner portion 318 contacts the guide cylinder 50 or is spaced therefrom when attached to the machining device 10. The inner portion 318 is disposed radially inwards of the radially outer cutting edge area 308 and configured to have the arcuate shape. Both the radially outer cutting edge area 308 and the inner portion 318 are planar in that they are configured to have the shape of a part of a cylindrical lateral surface.

The arcuate cutting tool part 306 further comprises a first coupling arrangement 320 having a first coupling portion 322, and a second coupling arrangement 324 having a second coupling portion 326. The two coupling arrangements 320, 324 are configured such that imaginary coupling to the respective other coupling arrangement is possible. If a second, similar arcuate cutting tool part were provided, it could be coupled to the coupling portions 320, 324 in an orientation rotated by 180° about the central axis M. The coupling portions 322, 326 can be understood as the respective end face or end face contour of the arcuate shape in the circumferential direction.

The first coupling portion 322 comprises a rectangular protrusion 325 which extends over the entire first coupling portion 322 in the radial direction R thereof while being located at the center of the first coupling portion 322 in the depth direction T. Thus, in addition to the protrusion 325, a first recessed surface 327 is formed in the direction of the side area 312 and a second recessed surface 328 is formed in the direction of the side area 314, which are substantially the same size and also rectangular. It is understood that the radial direction R can be understood as shown in FIG. 3 but may also comprise directions starting from the center point M0 in the direction of the arcuate cutting tool part (see FIG. 4) or several center points arranged along a straight line in the direction of the arcuate cutting tool part.

The second coupling portion 326 comprises a groove 330 which extends over the entire second coupling portion 326 in the radial direction R thereof while being located at the center of the second coupling portion 326 in the depth direction T. Thus, in addition to the groove 330, a first projecting surface 332 is formed in the direction of the side area 312 and a second projecting surface 334 is formed in the direction of the side area, which are substantially the same size and also rectangular.

The first coupling arrangement 320 comprises a first hole 336 whose central axis M1 is substantially perpendicular to the plane of the first coupling portion 322, in particular perpendicular to the plane spanned by the protrusion 325. The first hole 336 is configured as a blind hole and comprises an internal thread.

The second coupling arrangement 324 comprises a second hole 338 whose central axis M2 is substantially perpendicular to the plane of the second coupling portion 326, in particular perpendicular to the plane spanned by the groove 330. The second hole 338 is configured as a through hole. As can be seen particularly in FIG. 4, the hole 338 comprises a first hole portion 340 having a first diameter, and a second hole portion 342 having a second diameter, the first diameter being smaller than the second diameter. The first hole portion 340 serves to receive a screw shaft, and the second hole portion 342 serves to receive a screw head.

The arcuate cutting tool part 306 has a symmetry plane. The plane of symmetry is spanned through the radial direction R upon rotation about the center point M0 and is arranged in the depth direction T at the center of the arcuate cutting tool part 306. Accordingly, the central axes M1 and M2 lie in the plane of symmetry.

The arcuate cutting tool part 306 further comprises an attachment arrangement 344 on the cutting tool part carrier 302. The attachment arrangement 344 comprises a plurality of fastening holes 346 which are formed on the arcuate cutting tool part 306 and extend through the entire arcuate cutting tool part 306 from the side area 312 to the side area 314. In the present case, the fastening holes 346 are arranged on a pitch circle around the center point M0 and equally spaced in the circumferential direction. In the radial direction, the fastening holes 346 are located closer to the inner portion 318 than to the radially outer cutting edge area 308. The fastening holes 346 are arranged in the radial direction R at approximately one third of the thickness of the arcuate cutting tool part 306.

Since the holes 336, 338 are formed differently, it may be provided, as in the present case, that the fastening holes 346 located on the outside in the circumferential direction are spaced differently from the respective nearest coupling portion 322, 326. In the circumferential direction, the fastening hole 346 closest to the hole 336 is located closer to the hole 336 than the fastening hole 346 closest to the hole 338 in the circumferential direction. In particular, in the circumferential direction, the fastening hole 346 closest to the hole 336 is offset from the hole 336 at an angle w1 of less than 30°, preferably about 18°, about the center point M0, wherein the fastening hole 346 closest to the hole 338 in the circumferential direction is arranged at an angle of about 27° to the hole 338, although other angles could be selected.

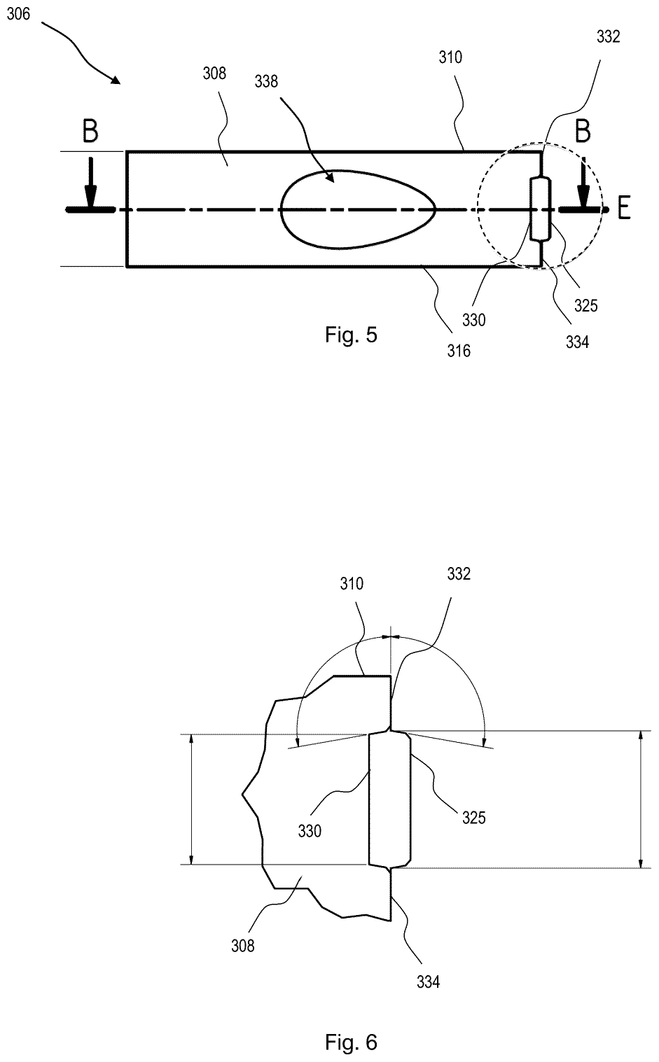

FIG. 5 is a view, but a bottom view, of the arcuate cutting tool part 306 according to the invention of FIG. 3. The bottom view shows that the hole 338 forms an oval, even egg-shaped, recess due to the arcuate configuration of the radially outer cutting edge area 308.

As with FIG. 6, which is a detailed view E of the arcuate cutting tool according to the invention as shown in FIG. 5, FIG. 5 further illustrates the first projecting surface 332, the second projecting surface 334 and the groove 330 of the second contact portion 326. It is clear that the projecting surfaces 332, 334 project slightly with respect to the groove 330 and are parallel to each other. In addition, the protrusion 325 of the first coupling portion 322 is visible while the recessed surfaces 327, 328 are concealed by the projecting surfaces 332, 334. It is understood that the recessed surfaces 327, 328 are parallel to the projecting surfaces 332, 334. It can further be seen that the protrusion 325 is substantially complementary to the groove 330.

In particular, FIG. 6 shows that the groove 330 tapers inwards to form a trapezoid. Further, the protrusion 325 tapers outwards to form a trapezoid. As in the present case, an angle of substantially 10° relative to the projecting surfaces 332, 334 or the recessed surfaces 327, 328 may be provided for the taper, although other angles may be provided.

FIG. 5 further shows the sectional plane B-B which represents the plane of symmetry and on which the illustration of FIG. 4 is based.

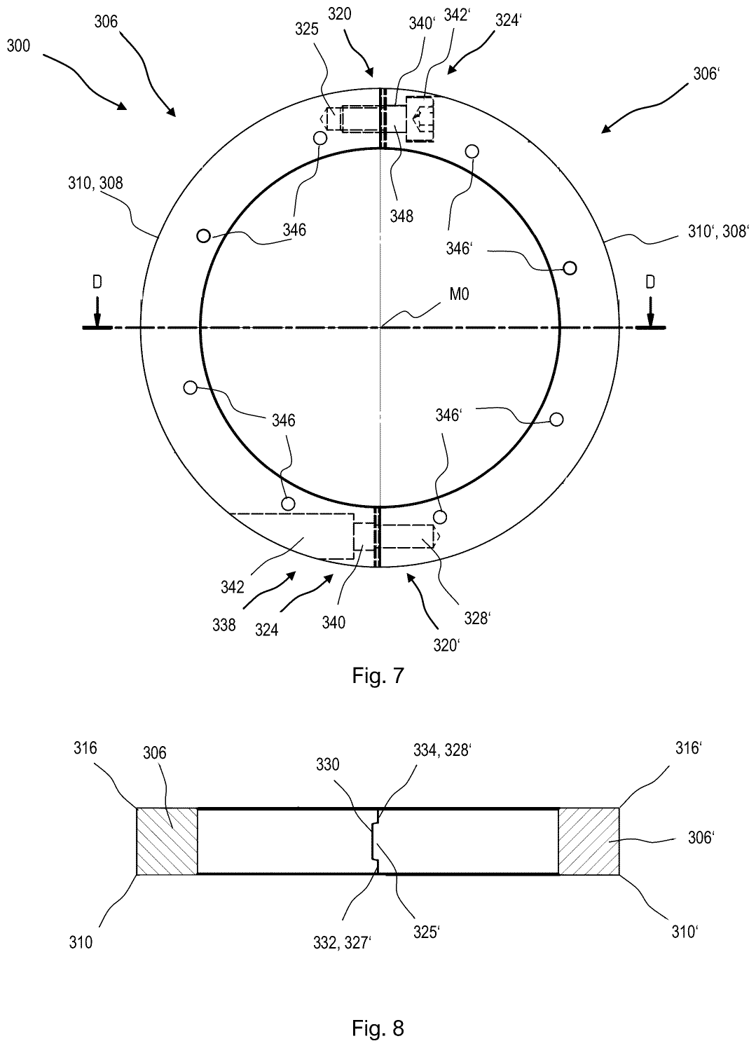

FIG. 7 illustrates the arcuate cutting tool 300 according to the invention. FIG. 8 is a sectional view of the arcuate cutting tool 300 according to the invention along the line D-D in FIG. 7. The arcuate cutting tool 300 comprises the cutting tool part 306, hereinafter referred to as the first cutting tool part 306, and a second cutting tool part 306′. The second cutting tool part 306′ corresponds to the first cutting tool part 306 but is rotated by 180°, namely about the plane D-D. In other words, one could say that the second cutting tool part 306′ is a mirror image of the first cutting tool part 306 at the center point M0.

The two cutting tool parts 306, 306′ do not necessarily have to be identical. It is sufficient that the first coupling arrangement 320′ of the second cutting tool part 306′ can be coupled to the first or the second coupling arrangement 320, 324 of the first cutting tool part 306 and that the second coupling arrangement 324′ of the second cutting tool part 306′ is coupled to the other of the first and the second coupling arrangements 320, 324 of the first cutting tool part 306.

In the present case, the first coupling portion 322 of the first cutting tool part 306 contacts the second coupling portion 326′ of the second cutting tool part 306′. Further, the second coupling portion 326 of the first cutting tool part 306 contacts the first coupling portion 322′ of the second cutting tool part 306′. As can be seen particularly in FIG. 8, the protrusion 325′ of the second cutting tool part 306′ extends into the groove 330 of the first cutting tool part 306. Similarly, as shown in FIG. 7, the protrusion 325 of the first cutting tool part 306 extends into the groove 330′ of the second cutting tool part 306′.

The contact between the coupling portions 322 and 326′ or between the coupling portions 322′ and 326 prevents relative displacement of the cutting tool parts 306, 306′ in the depth direction of FIG. 7 by virtue of their contours. In addition, the respective trapezoidal tapers of the grooves 330, 330′ and the protrusions 325, 325′ result in precise positioning of the cutting tool parts 306, 306′ so that the cutting edges 310, 310′ are aligned with each other in the circumferential direction. This allows the cutting edges 310, 310′ to be assembled into a single imaginary cutting edge.

As can be seen particularly in FIG. 8, the second projecting surface 334 of the first cutting tool part 306 and the second recessed surface 328′ of the second cutting tool part 306′ are in contact. Accordingly, the first projecting surface 332 of the first cutting tool part 306 and the first recessed surface 327′ of the second cutting tool part 306′ are in contact. In both cutting tool parts 306, 306′, the cutting edges 310, 316, 310′, 316′ are shown at least as sections. The cutting edges 310, 310′ form a common, complete and circular cutting edge. The cutting edges 316, 316′ also form a common, complete and circular cutting edge. It may be sufficient that there is only one of the complete cutting edges or that only one of the cutting edges 310, 316 or 310′, 316′ is formed on each of the cutting tool parts.

The arcuate cutting tool 300 further comprises two connecting means, wherein only one connecting means 348, i.e. a screw, is illustrated in the present case. The screw is disposed in the holes 338′ and 336. The screw is screwed into the thread of the hole 336, fastening the first coupling arrangement 320 of the first cutting tool part 306 to the second coupling arrangement 324 of the second cutting tool part 306′. Similarly, a second screw could be provided, which is disposed in the holes 338 and 336′, coupling or fastening the second coupling arrangement 324 of the first cutting tool part 306 to the first coupling arrangement 320′ of the second cutting tool part 306′. The screw may be configured as a round head screw, for example with a hexagon socket profile.

As can be seen particularly in FIG. 7, the holes 336, 338 or 336′, 338′ of the arcuate cutting tool part 306 or 306′ are arranged such that the connecting means 348, when attached to the cutting tool part 306 or 306′, is located entirely within the cutting tool part, i.e. in an area between the radially outer cutting edge area 308, 308′ and the inner portion 318, 318′. In other words, the connecting means 348 extends neither into the radially outer cutting edge area 308, 308′ nor into the inner portion 318, 318′. This helps to achieve a particularly compact design in which the connecting means 348 does not interfere with the cutting edges 310, 316 or the cutting function of the cutting tool. At the same time, the cutting tool 300 is easy to remove from the guide cylinder 50 or the cutting tool part carrier 302 for replacement of the cutting tool 300.

It can be seen that, when assembled, the arcuate cutting tool 300 has a cross-sectional contour in the form of a circular ring. As can be seen particularly in FIGS. 3 and 4, the cutting tool part 306 has a semicircular ring contour.

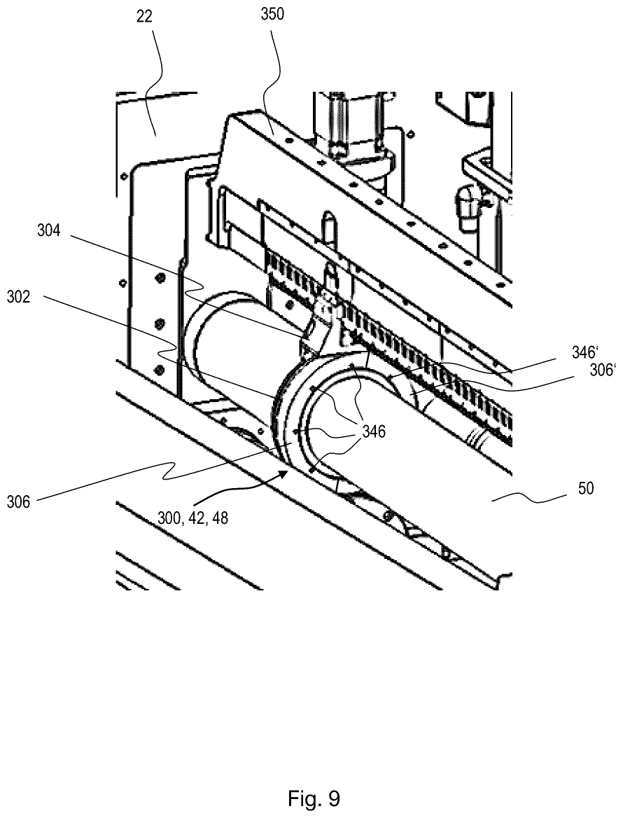

FIG. 9 is a detailed representation of FIG. 1. The cutting tool part 300 is attached to the cutting tool part carrier 302 with screws, not shown in detail, which are disposed in the fastening holes 346 and 346′ of the cutting tool parts 306 and 306′. The cutting tool part carrier 302 may be ring-shaped and surround the guide cylinder 50. If the guide cylinder 50 is configured differently, the shape of the cutting tool part carrier 302 may vary accordingly. If the machining device 10 is not equipped with a guide cylinder 50 at all, the cutting tool part carrier 302 may also have the shape of a circular disc or another shape, for example. The cutting tool part carrier 302 could be fixedly and/or releasably coupled to the linear guide 304. It is understood that if the force exerted on the cutting tool 300 during a cutting operation is transmitted in whole or at least in part to the linear guide 304 rather than to the guide cylinder 50, the linear guide 304 must have an appropriately stable design. The linear guide 304 is attached to the guide strut 350 which extends between the two side walls 20, 22 in the transverse direction Q so as to be linearly displaceable in the transverse direction Q. The linear guide 304 is configured to be driven by a motor. The linear guide may be arranged at various positions along the guide cylinder 50 in the transverse direction Q to cut the flat material FM in the feed direction V.

The cutting tool parts 306, 306′ or the cutting tool part 300 according to the invention come with the particular advantage of being very easy to replace in the machining device 10. If the cutting tool part 300 is to be replaced, for example because it is worn or a variant of the cutting tool is to be installed instead, this can be done easily without wasting time on removing parts of the machining device 10. In the present case, a replacement would require first loosening the screws in the fastening holes 346. The cutting tool 300 is then displaceable on the guide cylinder 50 in the transverse direction Q. With prior-art cutting tools, it would now be necessary to remove the guide cylinder 50, which is very time-consuming. Thanks to the present invention, in particular thanks to the division of the arcuate cutting tool 300 into two or more arcuate cutting tool parts 306, 306′, this work step is not necessary. Only the two connecting means 348 need to be loosened so that the two cutting tool parts 306, 306′ can be separated from each other for subsequent removal from the machining device 10. Installation of the same or a variant of the cutting tool 300 is carried out in the reverse order of the above steps.

In the following, features of the machining device 10 in particular will be explained in more detail in connection with the separative machining unit 34 or the punching unit 34. However, it is noted that the separative machining unit 34 or the punching unit 34 and related features relate to optional features of the machining device 10. The punching tool 40 or the blade 44 and related features also relate to optional features of the machining device 10. For a machining device 10 according to the invention, it may be sufficient to comprise the base 12 including a support table for the flat material FM, the base defining a feed direction V in which the flat material FM can be fed into the machining device, and a cutting device arrangement 40; 42 configured to cut the flat material (FM), the cutting device arrangement 40; 42 comprising at least one cutting tool part 306 of the above type and/or a cutting tool 300 of the above type.

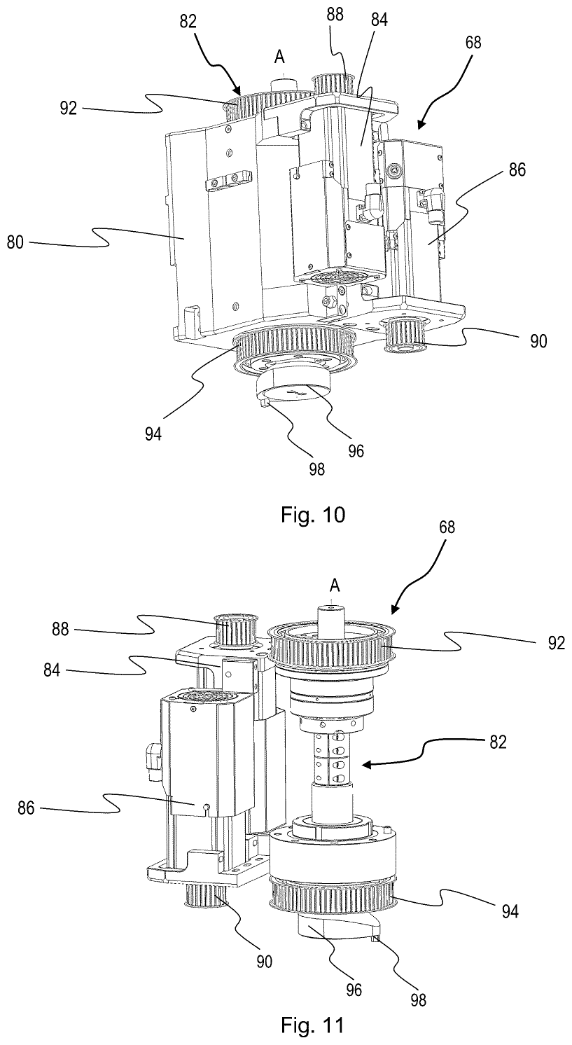

A spatial representation of an upper part of the machining head 86 is now shown in FIG. 10. It comprises a housing 80 which houses a double-spindle drive 82 with drive spindles oriented in opposite directions. FIG. 11 also shows the upper part of the machining head 68, but from a different perspective, with part of the housing 80 omitted. In addition to the double-spindle drive 82, the machining head 68 has two drive motors 84, 86. These two drive motors are each provided with an output gear 88, 90, each of which can drive corresponding drive gears 92, 94 of the double-spindle drive 82 via a toothed belt (not shown). FIGS. 10 and 11 further illustrate a force output member 96 with an eccentrically protruding lug 98. For further explanation, it is also pointed out that the double-spindle drive 82 has an axis of rotation A.

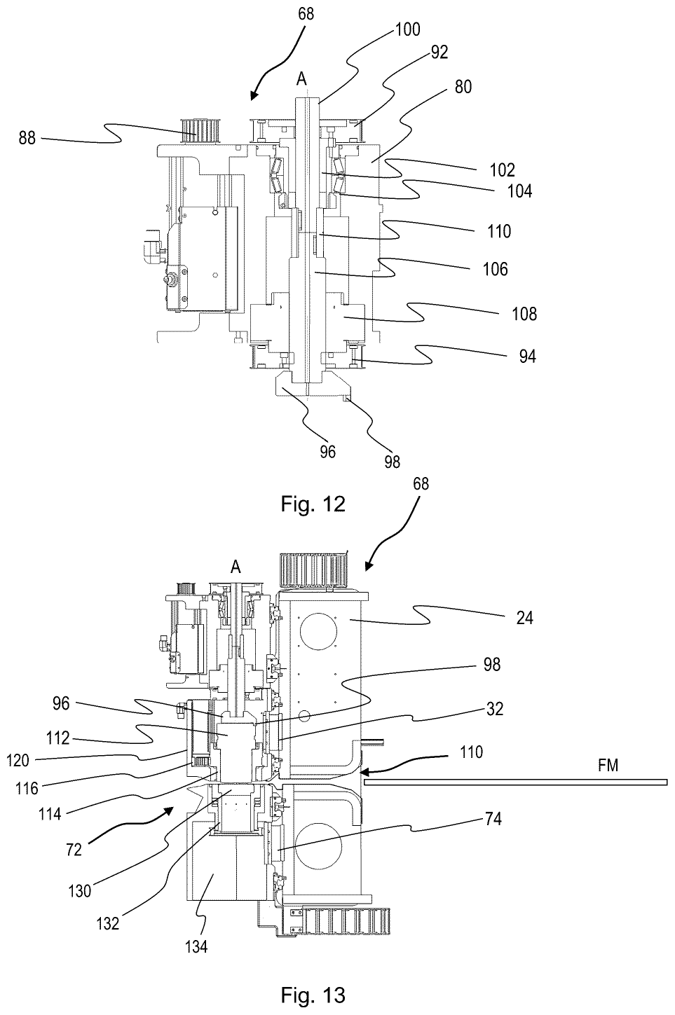

FIG. 12 is a section, which contains an axis, of the machining head 68 along the axis A. It illustrates the force output member 96 with the protruding lug 98. A first spindle 100 is received in a first spindle sleeve 102. The spindle sleeve 102 is rotatably driven by means of the output gear 88 and the drive gear 92. It is rotatably supported in the housing 80 about the axis A by means of a bearing arrangement 104. A second spindle 106 is received in a second spindle sleeve 108. The spindle sleeve 108 is rotatably driven by means of the output gear 90 (not shown) and the drive gear 94. The spindles are coupled to each other by means of a coupling part 110. In principle, the mode of operation is known from the prior art, for example from document EP 1 748 853 B1. The two drive motors 84, 86 are controllable so as to be able to drive the two drive gears 92, 94 with opposite or the same orientation, i.e. with opposite or the same direction of rotation. If both spindle sleeves 102 and 108 rotate in the same direction, this only results in a rotational movement of the force output member 96 and thus twisting of the lug 98 about the axis A, so that the angular position of the eccentrically protruding lug 98 about the axis of rotation A changes. If both spindle sleeves 102 and 108 rotate in opposite directions, this results in a stroke movement of the spindle 106 and thus a stroke movement of the force output member 96 along the axis A in the stroke direction.

In FIG. 13, the machining head 68 is now coupled to the portal 24 together with the die unit 72 which is attached to the linear guide 74 of the lower part of the portal 24. It can be seen that the portal 24 defines, in its upper and lower areas, a conically tapering inlet area 110 in the form of a gap for the flat material FM. This ensures that the flat material FM is guided into the area where the machining head 68 and the die unit 72 interact in a predetermined orientation. It can also be seen that the force output member 96 of the machining head 68 is coupled to a punching tool assembly 112. The punching tool assembly 112 is fixedly received in an assembly carrier 114 but can be removed therefrom for maintenance or replacement. The assembly carrier 114 is rotatably displaceable relative to a housing 120 by means of a rotary drive 116. This means that the punching tool assembly 112 can be twisted about the axis A relative to the housing 120 as required.

In the upper part of FIG. 13, it can also be seen that the punching tool assembly 112 is coupled to the protruding lug 98 of the force output member 96. The lug 98 engages with a corresponding recess on a reciprocating piston (not shown) of the punching tool assembly 112. By twisting the lug 98 of the force output member 96, the reciprocating piston of the punching tool assembly 112 can be twisted therein. However, when the force output member 96 of the machining head 34 is displaced in the direction of the axis A to perform a stroke movement, the reciprocating piston of the punching tool assembly 112 can be displaced correspondingly in the axial direction to achieve a stroke movement of a single punching tool. This will be explained in detail below.

FIG. 13 also shows the die unit 72. It comprises a die plate 130 that is accommodated in a rotatable die carrier 132. The die carrier 132 is supported in a housing 134 and twistable by means of a separate rotary drive which is controlled synchronously with the rotary drive 116.

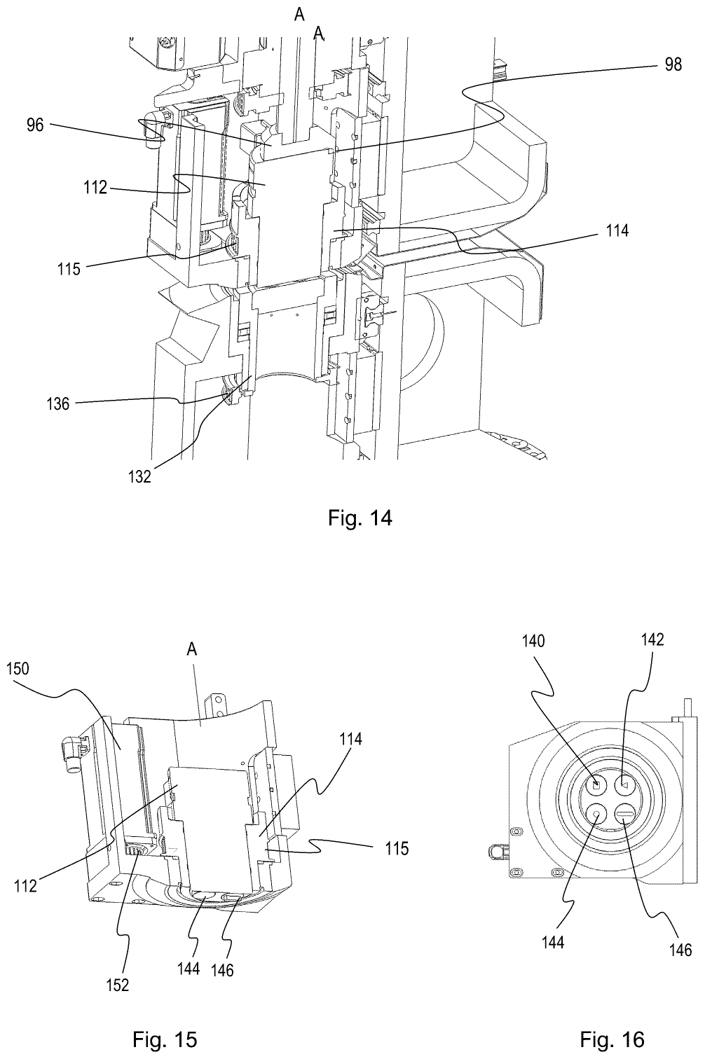

FIG. 14 again shows in detail the arrangement with respect to the coupling of the force output member 96 to the punching tool 112. It can be seen how the lug 98 engages with the reciprocating piston (not shown) of the punching tool assembly 112. FIG. 14 further shows that the carrier 114 for the punching tool assembly 112 is provided with external toothing 115 so that it can be rotatably driven. In addition, FIG. 14 shows that the carrier 132 is also provided with external toothing 136 so that the die plate 130 is displaceable with the carrier 132 about the axis A.

FIGS. 15 and 16 show further details with respect to the punching tool assembly 112. In particular, the bottom view of FIG. 16 shows that the punching tool assembly 112 comprises four different punching tools, i.e. a substantially square punching tool 140, a triangular punching tool 142, a circular punching tool 144, and an elongate punching tool 146. In the perspective partial sectional view of FIG. 15, only the two punching tools 144 and 146 are shown. Each of the four punching tools can be specifically controlled by twisting the reciprocating piston of the punching tool assembly 112 by means of the lug 98 of the force output member 96 so that it is aligned with the punching tool to be selected. A stroke movement of the force output member 96 then specifically results in the stroke movement of the selected punching tool, for example the elongate punching tool 146, while all other punching tools 140, 142, 144 remain passive in this example.

FIG. 15 further shows a drive motor 150 including an output gear 152 which interacts with the drive gear 115 on the carrier 114 for the punching tool assembly 112. Accordingly, a separate drive is provided for twisting the punching tool assembly 112 so that the punching tool 146 selected in the example can be brought to any angular position relative to the axis A.

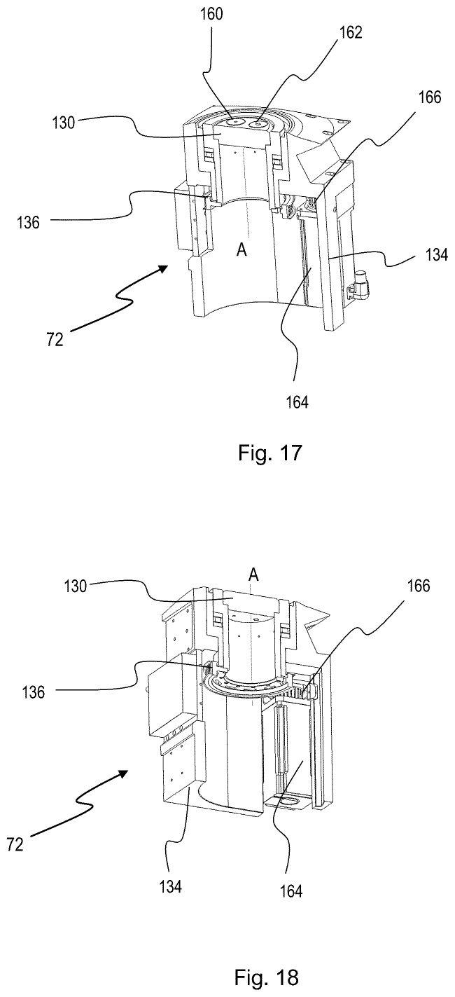

Finally, the die unit 72 including the die plate 130 are shown in FIGS. 17 and 18. The die plate 130 comprises die recesses which are complementary to the respective profile of the punching tools 140, 142, 144 and 146, only two of which are shown in FIG. 17, namely the two die recesses 160, 162. Furthermore, FIGS. 17 and 18 show a drive motor 164 including an output gear 166 which is configured to rotatably drive the drive gear 136 and thus the die carrier 132 via a toothed belt which is not shown. As a result, the individual die recesses in the die plate 130 can also be twisted about the axis A to any desired angular position. It is understood that the twisting of the die plate 130 is synchronised and aligned with the twisting of the punching tool assembly 130 to keep the selected punching tool 140, 142, 144 or 146 correctly aligned with the respective recess in the die plate 130.

The invention enables the flat material FM to be cut both in the transverse direction Q and in the feed direction V by means of the two cutting devices 40 and 42. Furthermore, the machining head 68 and the associated die unit 72 can be used to punch the flat material FM as desired and cut it in sections, for example with the elongate punching tool 146. The punching operating can be assisted by the fact that the entire portal 24 including the machining head 68 and associated die unit 72 is also displaceable along the linear guide 30. This makes it possible, for example, to fix the flat material FM for a specific machining operation in the base relative to the feed direction V while performing a punching operation in a specific area of the flat material FM. Since in the embodiment shown, the machining head 68 is configured with a double-spindle drive with drive spindles rotating in opposite directions, the machining head 68 may be configured to be relatively self-sufficient. It only needs to be powered and connected to the control unit. For example, there is no need for supply lines for a hydraulic system or the like. In addition, the machining head 68 has a sturdy design. The use of a punching tool assembly 112 with a plurality of punching tools offers greater flexibility and, in particular, considerable advantages over the document EP 1 748 843 B1 discussed at the beginning.

All in all, the device according to the invention is a compact machine that both cuts flat material FM and performs punching operations.

The invention also relates to the following aspects:
1. A machining device (10) for cutting and punching flat material (FM), such as sheet metal, comprising:
   a base (12) including a support table for the flat material (FM), the base (12) defining a feed direction (V) in which the flat material (FM) can be fed into the machining device (10),
   a first cutting device (40) configured to cut the flat material (FM) transversely to the feed direction (V), and
   a second cutting device (42) configured to cut the flat material (FM) in the feed direction (V),
wherein the machining device (10) further comprises a separative machining unit (34) configured to be displaceable in the machining device (10) relative to the base (12) transversely to the feed direction (V), wherein the separative machining unit (34) is configured to subject the flat material (FM) to separative machining in sections.
2. The machining device (10) of aspect 1, wherein a guide portal is provided on the base (12), which is arranged transversely to the support table (14), the guide portal (24) having a guide device which makes the separative machining unit (34) displaceable in a guided manner relative to the base (12), the guide device in particular comprising a linear guide.
3. The machining device (10) of aspect 2, wherein the guide portal (24) is configured to be displaceable relative to the base (12) in the feed direction (V).
4. The machining device (10) of aspect 3, wherein the flat material (FM) is displaceable on the support table (14) relative to the base (12) in the feed direction (V) with a feed device.
5. The machining device (10) of any one of the preceding aspects, wherein the base (12) has a fixing device for temporarily fixing the flat material (FM) on the support table (14).
6. The machining device (10) of any one of the preceding aspects, wherein the first cutting device (40) comprises a guillotine shearing device or a rotary shearing device.
7. The machining device (10) of any one of the preceding aspects, wherein the second cutting device (42) comprises a circular blade device or a rotary shearing device.
8. The machining device (10) of any one of the preceding aspects, wherein the separative machining unit (34) is configured with a laser machining unit and/or a punching unit (34).
9. The machining device (10) of aspect 8, wherein the punching unit is configured as a hydraulic or/and mechanical punching unit (34).
10. The machining device (10) of aspect 8 or 9, wherein the punching unit (34) comprises a plurality of punching tools (140, 142, 144, 176) that can be optionally selected for machining the flat material (FM).
11. The machining device (10) of aspect 10, wherein the mechanical punching unit (34) is configured with a motor-driven double-spindle arrangement (82) with spindle drives rotating in opposite directions and a drive control, wherein a force output member (96) is selectively displaceable in a stroke direction perpendicular to the feed direction (V), in particular perpendicular to a main direction of extension of the flat material (FM), and/or twistable relative thereto.
12. A punching unit (34) for punching flat material (FM), in particular a machining head for a machining device (10) of any one of the preceding aspects, wherein the machining head comprises:
   a housing defining a stroke axis (A);
   a mechanical or hydraulic lifting device comprising a force output member (96);
   a tool receptacle (112) for receiving at least one cutting or punching tool, which is mounted in the housing so as to be rotatable about an axis of rotation (A);
   at least one cutting or punching tool (140, 142, 144, 146) which can be received in the tool receptacle (112) and is displaceable in the direction of the stroke axis along a tool longitudinal axis, wherein the cutting or punching tool is displaceable along its tool longitudinal axis via the force output member (96);
   a rotatable positioning device for rotatably positioning the at least one cutting or punching tool (150, 152, 115); and
   a die unit (72) which is configured to interact with the at least one cutting or punching tool and can be aligned in accordance with its rotatable positioning.
13. The punching unit (34) of aspect 12, wherein the rotatable positioning device is configured to rotatably position the cutting or punching tool (140, 142, 144, 146) about its tool longitudinal axis and/or about the stroke axis.
14. The punching unit (34) of aspect 12 or 13, wherein the lifting device is configured with a hydraulic piston that displaces the force output member in the lifting device by at least a predetermined stroke distance.
15. The punching unit (34) of aspect 12 or 13, wherein the lifting device is configured with a spindle arrangement, in particular with a double-spindle arrangement (82), wherein the double-spindle arrangement is equipped with a first spindle drive and a second spindle drive, wherein the first and second spindle drives have drive spindles configured to rotate in opposite directions, wherein in first and second spindle drives that are rotatably driven in the same direction, the force output member can be positioned rotatably about the stroke axis, wherein in first and second spindle drives that are rotatably driven in opposite directions, the force output member is displaceable along the stroke axis in the stroke direction.
16. The punching unit (34) of aspect 15, wherein the tool receptacle comprises a turret with a plurality of cutting or punching tools (140, 142, 144, 146) received therein, each of the cutting or punching tools being selectively activatable for machining the flat material (FM).
17. The punching unit (34) of aspect 16, wherein the force output member (96) comprises a coupling member that is arranged eccentrically relative to the stroke axis and can optionally be positioned rotatably about the stroke axis, wherein the respective cutting or punching tool can be activated for machining the flat material (FM) in accordance with the rotational position of the coupling member about the stroke axis while cutting or punching tools that have not been activated remain passive.
18. The punching unit (34) of aspect 16 or 17, wherein the tool receptacle (112) is assigned a reciprocating piston which can be coupled to the force output member and which makes the respectively activated cutting or punching tool (140, 142, 144, 146) displaceable along its tool longitudinal axis in the stroke direction.
19. The punching unit (34) of any one of aspects 12 to 18, wherein a rotary drive (150) is assigned to the tool receptacle (112), with which the tool receptacle can be positioned rotatably about the stroke axis relative to the housing, wherein the alignment of the at least one cutting or punching tool (140, 142, 144, 146) of the stroke axis can be changed in accordance with the rotational position of the tool receptacle.
20. The punching unit (34) of any one of aspects 12 to 19, wherein a rotary drive is assigned to the die unit (72), with which a die that receives the respectively activated cutting or punching tool and is complementary to the activated cutting or punching tool (140, 142, 144, 146) can be positioned rotatably about the stroke axis relative to the housing, wherein the die can be positioned in accordance with the alignment and positioning of the activated cutting or punching tool (140, 142, 144, 146) of the stroke axis.

1. An arcuate cutting tool part for a machining device for cutting flat material, such as sheet metal, comprising:
a radially outer cutting edge area having at least one arcuate cutting edge;
an attachment arrangement for attachment to the machining device;
a first coupling arrangement having a first coupling portion; and
a second coupling arrangement having a second coupling portion,
wherein the arcuate cutting tool part defines a circumferential direction in accordance with an arcuate shape of the arcuate cutting tool part, and
wherein at least one of the first and the second coupling arrangements are configured to be releasably coupled to at least one further arcuate cutting tool part in the circumferential direction.

2. The arcuate cutting tool part of claim 1, wherein the first and the second coupling arrangements are configured such that imaginary coupling to the respective other of the first and second coupling arrangements is provided.

3. The arcuate cutting tool part of claim 1, wherein the first and the second coupling arrangements are coupled together by way of positive abutment with one another without an additional component arranged between the first and the second coupling arrangements.

4. The arcuate cutting tool part of claim 1, wherein the first and the second coupling portions are configured to be at least partially complementary to each other.

5. The arcuate cutting tool part of claim 1, wherein the first coupling portion and/or the second coupling portion have a groove and/or a protrusion, wherein the groove is configured to receive the protrusion.

6. The arcuate cutting tool part of claim 1, wherein at least one of the first and the second coupling arrangements has at least one recess for receiving a connecting means.

7. The arcuate cutting tool part of claim 6, wherein the connecting means comprises a screw.

8. The arcuate cutting tool part of claim 1, further comprising a radially inner portion that at least partially surrounds a part of the machining device.

9. The arcuate cutting tool part of claim 8, wherein the radially inner portion is arcuate, and wherein the part of the machining device comprises a guide cylinder.

10. The arcuate cutting tool part of claim 1, wherein the at least one arcuate cutting edge has the shape of a segment of a circle.

11. The arcuate cutting tool part of claim 1, wherein the arcuate cutting tool part has the shape of a segment of a ring.

12. The arcuate cutting tool part of claim 1, wherein the arcuate cutting tool part has a substantially constant thickness at least in the radial direction.

13. The arcuate cutting tool part of claim 1, wherein the attachment arrangement comprises one or more fastening holes for at least partially receiving a respective connecting means for attachment to the machining device.

14. The arcuate cutting tool part of claim 13, wherein the fastening holes are arranged along a pitch circle.

15. An arcuate cutting tool for a machining device for cutting flat material, the arcuate cutting tool comprising:
a first cutting tool part, comprising:
a first radially outer cutting edge area having at least one first arcuate cutting edge;
a first attachment arrangement for attachment to the machining device; and
a first set of coupling arrangements,
wherein the first arcuate cutting tool part defines a first circumferential direction in accordance with a first arcuate shape of the first cutting tool part, and
a second cutting tool part, comprising:
a second radially outer cutting edge area having at least one second arcuate cutting edge;
a second attachment arrangement for attachment to the machining device;
a second set of coupling arrangements,
wherein the second arcuate cutting tool part defines a second circumferential direction in accordance with a second arcuate shape of the second cutting tool part, and
wherein a coupling arrangement of the second set of coupling arrangements is coupled to a coupling arrangement of the first set of coupling arrangements.

16. The arcuate cutting tool of claim 15, further comprising at least one connecting means for releasably coupling the first cutting tool part to the second cutting tool part.

17. The arcuate cutting tool of claim 15, wherein the first and the second cutting tool parts are similar.

18. A machining device for cutting flat material, comprising:
a base including a support table for the flat material, the base defining a feed direction in which the flat material can be fed into the machining device; and
a cutting device arrangement configured to cut the flat material, comprising:
a radially outer cutting edge area having at least one arcuate cutting edge;
an attachment arrangement for attachment to the machining device;
a first coupling arrangement having a first coupling portion; and
a second coupling arrangement having a second coupling portion,
wherein the cutting device arrangement defines a circumferential direction in accordance with an arcuate shape of the cutting device arrangement, and
wherein at least one of the first and the second coupling arrangements are configured to be releasably coupled to another cutting device arrangement in the circumferential direction.

19. The machining device of claim 18, wherein the cutting device arrangement comprises a first cutting device configured to cut the flat material transversely to the feed direction, wherein the machining device further comprises a second cutting device arrangement comprising a second cutting device configured to cut the flat material in the feed direction, wherein the second cutting device arrangement defines a second circumferential direction in accordance with a second arcuate shape of the second cutting device arrangement, and wherein the second cutting device arrangement comprises:
a second radially outer cutting edge area having at least one second arcuate cutting edge;
a second attachment arrangement for attachment to the machining device; and
at least one coupling arrangement configured to be releasably coupled the first cutting device arrangement.
